(19) United States
(12) Patent Application Publication
(10) Pub. No.: US 2015/0124021 A1
(43) Pub. Date: May 7, 2015

(54) IMAGE FORMING APPARATUS, IMAGE FORMING SYSTEM, AND IMAGE FORMING METHOD

(71) Applicant: Konica Minolta Inc., Tokyo (JP)

(72) Inventor: Takashi YAMASHITA, Hino-shi (JP)

(73) Assignee: KONICA MINOLTA INC., Tokyo (JP)

(21) Appl. No.: 14/534,293

(22) Filed: Nov. 6, 2014

(30) Foreign Application Priority Data
Nov. 7, 2013 (JP) 2013-230925

(51) Int. Cl. B41J 2/045

(52) U.S. Cl. CPC B41J 2/04536
USPC 347/20

(57) ABSTRACT

An image forming apparatus, which can be connected to a different image forming apparatus in series-tandem, includes: an image forming unit configured to perform image forming based on image data; a communication unit configured to communicate with the different image forming apparatus; and a control unit configured to control the image forming and the communication, wherein the control unit acquires own apparatus coverage in print history of the own apparatus, acquires different apparatus coverage in print history of the different image forming apparatus through the communication unit, and compares the own apparatus coverage and the different apparatus coverage, and when the own apparatus coverage is high and a difference therebetween exceeds a predetermined deviation value, the control unit performs control to execute stabilization control by density adjustment.

The entire disclosure of Japanese Patent Application No. 2013-230925 filed on Nov. 7, 2013 including description, claims, drawings, and abstract are incorporated herein by reference in its entirety.

### BACKGROUND OF THE INVENTION

1. Field of the Invention

The present invention relates to image forming apparatuses in series-tandem connection, an image forming system including the image forming apparatuses, and an image forming method.

2. Description of the Related Art

Recently, while various kinds of printing are desired, it is also desired to speed up printing. To speed up printing, a technique to connect a plurality of image forming apparatuses such as a copier, a printer, and the like in series-tandem and to process one print job or the like by the plurality of image forming apparatuses has been known. For example, usage in which an image is formed on a surface side of paper by an image forming apparatus in a preceding stage and an image is formed on a rear surface side of the paper by an image forming apparatus in a following stage can be considered.

Generally, in an image forming apparatus, stabilization control is performed to adjust density to an adequate range. When a main image forming apparatus satisfies a certain condition (such as printing the prescribed number of pieces of paper, being left for a long period of time, or being activated for the first time in the morning), the stabilization control of a series-tandem system is executed in each image forming apparatus. However, in the image forming apparatuses in the series-tandem connection, when different images are respectively formed in the image forming apparatuses, a difference is likely to be generated in coverage. For example, when low coverage is printed continuously in one image forming apparatus and high coverage is continuously printed in the other image forming apparatus, pieces of coverage of the image forming apparatuses become different from each other and a difference is generated between print states of the two, and thus, quality of an output object may be influenced.

On the other hand, in JP 2012-150413 A, an image forming system, in which a density detection unit is provided between an apparatus in a preceding stage and an apparatus in a following stage and which performs density detection before image density printed in the apparatus in the preceding stage is printed in the apparatus in the following stage, has been proposed. In the image forming system, it is said that by giving feedback to printing in the apparatus in the following stage according to a result of the density detection, density variation from the apparatus in the preceding stage can be controlled without reducing productivity.

However, in the image forming system disclosed in JP 2012-150413 A, a purpose is to control variation in density between the apparatus in the preceding stage and the apparatus in the following stage. Thus, for example, in a case where density of the apparatus in the preceding stage is not adequate, even when density of the both apparatuses is made the same, density adjustment is still not adequate and print quality is deteriorated.

### SUMMARY OF THE INVENTION

The present invention has been made in consideration of the above circumstance and an object of the present invention is to provide, an image forming apparatus, an image forming system, and an image forming method which are capable of adjusting, in image forming apparatuses in series-tandem connection, density of both apparatuses adequately.

To achieve the above-mentioned object, according to an aspect of the present invention, an image forming apparatus which can be connected to a different image forming apparatus in series-tandem comprises: an image forming unit configured to perform image forming based on image data; a communication unit configured to communicate with the different image forming apparatus; and a control unit configured to control the image forming and the communication, wherein the control unit acquires own apparatus coverage in print history of the own apparatus, acquires different apparatus coverage in print history of the different image forming apparatus through the communication unit, and compares the own apparatus coverage and the different apparatus coverage, and when the own apparatus coverage is high and a difference therebetween exceeds a predetermined deviation value, the control unit performs control to execute stabilization control by density adjustment.

Also, an image forming system according to an aspect of the present invention comprises: a plurality of image forming apparatuses in series-tandem connection, each of which includes an image forming unit configured to form an image based on image data, a network communication unit which is connected to a network and is configured to perform network communication with an external part, and an image forming apparatus control unit configured to control the image forming and the network communication; and a management server including a management server communication unit which is connected to each of the image forming apparatuses via the network, and a management control unit configured to manage each of the image forming apparatuses, wherein the management control unit acquires, via the network, coverage in print history of each of the image forming apparatuses and when a difference in the coverage exceeds a predetermined deviation value, the management control unit at least gives notice of executing stabilization control by density adjustment in an image forming apparatus with high coverage in the image forming apparatuses having the difference.

Also, an image forming method according to an aspect of the present invention comprises: acquiring first coverage in print history of a first image forming apparatus and a second coverage in print history of a second image forming apparatus; comparing the first coverage and the second coverage; and performing, when either piece of the coverage is high and a difference therebetween exceeds a predetermined deviation value, control to execute stabilization control to perform density adjustment at least in an image forming apparatus with the high coverage.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a schematic configuration view including a control block in an embodiment of the present invention;

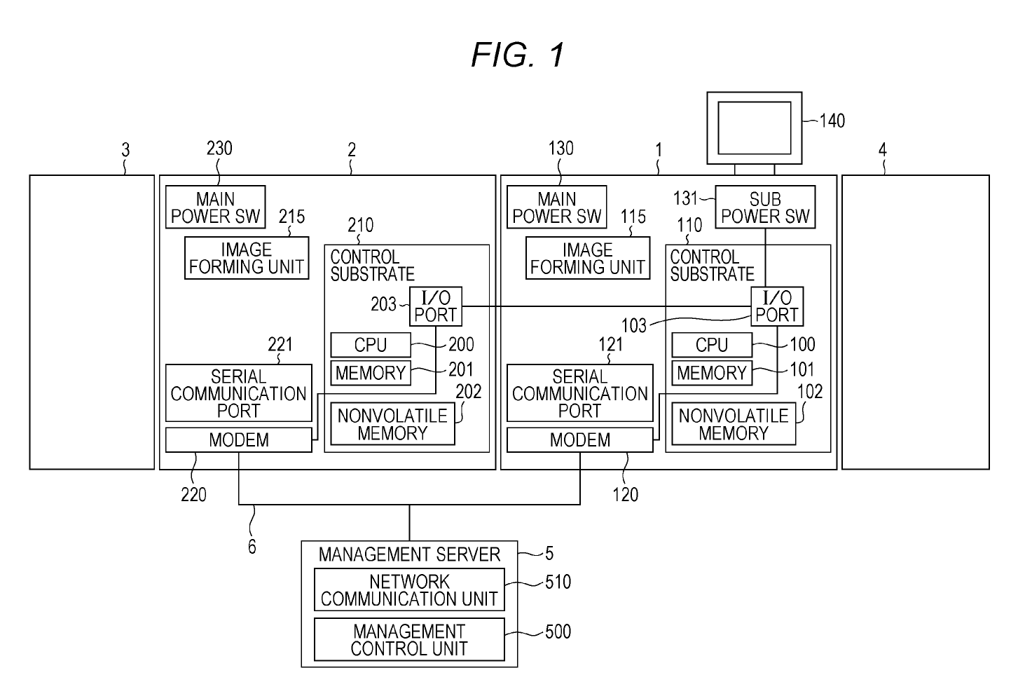

FIG. 2 is a graph illustrating a change in coverage integrated in each of an upstream image forming apparatuses and a downstream image forming apparatus;

FIG. 3 is a flowchart illustrating a processing procedure of the upstream image forming apparatus which performs determination of execution of stabilization control;

FIG. 4 is a flowchart illustrating a processing procedure of the downstream image forming apparatus which receives control of execution of stabilization control;

FIG. 5 is a flowchart illustrating a processing procedure of the upstream image forming apparatus which performs, for each color, determination of execution of stabilization control; and

FIG. 6 is a flowchart illustrating a processing procedure to perform determination of execution of stabilization control in a management server.

### DESCRIPTION OF THE PREFERRED EMBODIMENTS

Hereinafter, an embodiment of the present invention will be described with reference to the drawings. However, the scope of the invention is not limited to the illustrated examples.

Hereinafter, an image forming apparatus and an image forming system of an embodiment of the present invention will be described based on the drawings. However, the scope of the invention is not limited to the illustrated examples. In the image forming system, an image forming apparatus 1 which becomes an apparatus in a preceding stage and an image forming apparatus 2 which becomes an apparatus in a following stage are in series-tandem connection. On an upstream side in paper feeding direction of the image forming apparatus 2, a post-processing apparatus 3 is connected. On an upstream side in paper feeding direction of the image forming apparatus 1, a paper feeding unit 4 to feed paper to the image forming apparatus 1 is connected. The image forming system includes these apparatuses.

Also, the image forming apparatuses 1 and 2 are connected to a management server 5 and are managed when necessary. The image forming system may not include the management server 5. When the management server 5 is included, the image forming system includes the management server 5. Note that a configuration of the image forming system is not limited to what has been described above and image forming apparatuses in series-tandem connection only needs to be included. Also, in the following, description will be made on the assumption that two image forming apparatuses are in series-tandem connection, but a case where three or more image forming apparatuses are in series-tandem connection is also within the scope of the present invention.

The image forming apparatus 1 includes a CPU 100 to control the whole image forming apparatus 1. The image forming apparatus 1 also includes a memory 101 and a nonvolatile memory 102 each of which includes a ROM, a RAM or the like. A control substrate 110 includes the CPU 100, the memory 101, and the nonvolatile memory 102 and functions as a control unit of the present invention. In respect to an operation parameter to control the image forming apparatus 1 or in respect to stabilization control, the nonvolatile memory 102 stores data of a predetermined deviation value of a difference in coverage between different image forming apparatuses, a predetermined value of coverage of when stabilization control is executed, and the like. Also, a deviation value and a predetermined value may be different for each color.

An image forming unit 115 is to form an image on paper based on image data, and includes a charging unit, a writing unit, a developing unit, a transfer unit, a fixing unit, and the like. Also, in the image forming unit 115, it is possible to reverse paper on a surface of which an image is formed and to form an image on a rear surface. Paper on which an image is formed is ejected to the image forming apparatus 2. In the paper ejection, paper can be ejected by reversing the paper.

An I/O port 103 is an interface to communicate with the image forming apparatus 2 and corresponds to a communication unit of the present invention. The I/O port 103 is electrically connected, through a communication cable, to an I/O port 203 of the image forming apparatus 2 which will be described later. A modem 120 is connected to the management server 5 or an external apparatus through a network 6 such as a public line or a LAN. A serial communication port 121 is an interface to communicate with an external USB or the like. The modem 120 corresponds to a network communication unit of the present invention. Note that the image forming apparatus 1 includes a main power switch 130 and a sub power switch 131. Even when the sub power switch 131 is turned off, power is supplied to a part of devices such as a memory. When the main power switch 130 is turned off, power feeding to all the devices is stopped.

A display operation unit 140 is to receive an operation input of an operator and to display appropriate information. The display operation unit 140 includes an operation unit to receive an operation input and a display unit to perform displaying. The operation unit and the display unit may be configured separately, or the operation unit and the display unit may be configured integrally by a touch panel LCD or the like. In the operation unit, it is possible, for example, to set a print condition. Also, it may be possible to perform operation to change the described deviation value or predetermined value. Moreover, when control to execute stabilization control is performed, a message to request the stabilization control or the like may be displayed on the display unit.

The image forming apparatus 2 includes a CPU 200 to control the whole image forming apparatus 2. The image forming apparatus 2 also includes a memory 201 and a nonvolatile memory 202 each of which includes a ROM, a RAM or the like. A control substrate 210 includes the CPU 200, the memory 201, and the nonvolatile memory 202 and can function as a control unit of the present invention. In respect to an operation parameter to control the image forming apparatus 1 or in respect stabilization control, the nonvolatile memory 202 stores data of a deviation value of a difference in coverage between different devices or a predetermined value of when stabilization control is executed. Also, a deviation value and a predetermined value may be different for each color.

An image forming unit 215 is to form an image on paper based on image data and includes a charging unit, a writing unit, a developing unit, a transfer unit, a fixing unit, and the like. Also, in the image forming unit 215, it is possible to reverse paper on a surface of which an image is formed and to form an image on a rear surface. Paper on which an image is formed is fed to the post-processing apparatus 3.

An I/O port 203 is an interface to communicate with the image forming apparatus 2 and can function as a communication unit of the present invention. A modem 220 is connected to the management server 5 or an external apparatus through a network such as a public line or a LAN. A serial communication port 221 is an interface to communicate with an external USB or the like. The modem 220 corresponds to a network communication unit of the present invention. Note that the image forming apparatus 2 includes a main power switch 230. When the main power switch 230 is turned off, power feeding to all the devices is stopped.

The post-processing apparatus 3 performs, on the paper fed from the image forming apparatus 2, post-processing according to a set post-processing condition. Contents of the post-processing are not particularly limited and may be what includes a post-processing function such as stapling, punching, or case binding. When post-processing is not set, paper is ejected without post-processing.

The management server 5 is connected, via the network 6, to the image forming apparatuses 1 and 2 in a communicable manner respectively through the modems 120 and 220. The management server 5 includes a network communication unit 510 connected to the network, and a management control unit 500 to manage the whole management server 5 and the image forming apparatuses 1 and 2. Note in the image forming system, the management server 5 may not be necessary.

The management server 5 may function only as a server, or a software to perform management may be activated in an external terminal and may function as the management server 5.

In the present embodiment, a printing rate in print history of each of the image forming apparatuses is calculated in the CPU 100 or 200 and is stored into the memory 101 or 201, the nonvolatile memory 102 or 202, or the like as an integrated value (coverage). The printing rate is expressed, for example, by a dot area in a unit area, a cover rate in particular paper (such as A4), or the like and an integrated value thereof is measured as coverage. As described above, the integrated value is stored into the memory or the like. Along with printing, a printing rate is serially added and the integrated value is updated. In respect to coverage, which is used for determination of execution of stabilization control, of the present invention, comparison may be performed with respect to coverage of all pieces of paper being continuously printed or comparison may be performed with respect to an integrated value of coverage of paper being currently printed and a several preceding pieces of printed paper. The coverage can be set in an appropriate range. A range of print history may be set by an operator through the display operation unit 140.

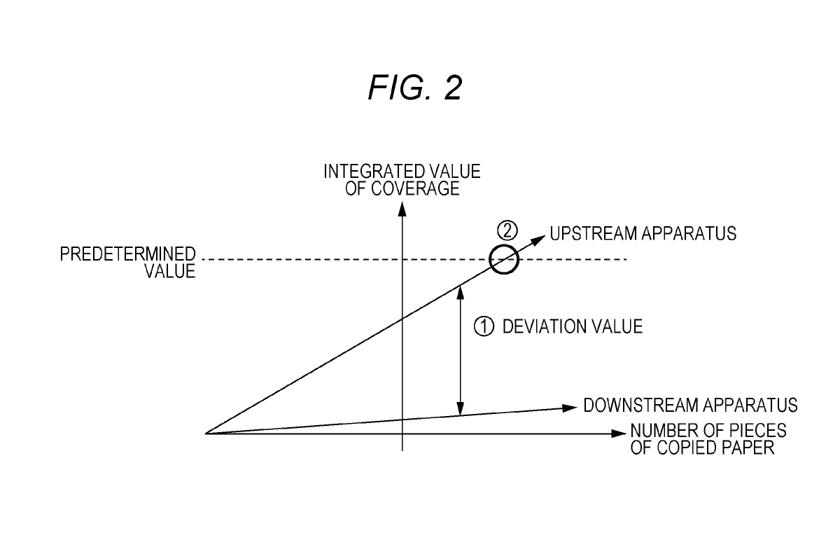

For example, when high coverage printing of a solid image or the like is performed in the image forming apparatus 1 which is an upstream apparatus and when low coverage printing of line art or the like is performed in the image forming apparatus 2 which is a downstream apparatus, coverage is gradually increased and a difference between the both apparatuses is increased as illustrated in FIG. 2. In the present embodiment, when a difference in coverage of the both apparatuses exceeds a predetermined deviation value, stabilization control by density adjustment is performed. Also, when either piece of coverage exceeds a predetermined value, the stabilization control by the density adjustment is performed. Even when a difference in the coverage of the image forming apparatuses does not exceed the predetermined deviation value, in a case where the predetermined value is exceeded, control to execute the stabilization control of at least an image forming apparatus which exceeds the predetermined value is performed. In a color image forming apparatus, coverage can be integrated by the sum of colors or determination can be performed with a color of coverage having the highest value. However, it is also possible to determine coverage of each color and to determine, for each color, necessity for the stabilization control. Also, it is possible to set a deviation value and a predetermined value which are different for each color. Specifically, in respect to a color which has influence on print quality, a deviation value and a predetermined value are made small to control deterioration of quality.

The stabilization control by the density adjustment can be performed by various methods. For example, by forming a test image on paper by image forming, measuring density of the test image with an image sensor, and by adjusting an image forming condition (charging bias of charging apparatus, exposure light quantity and exposure position of exposure apparatus, developing bias of developing apparatus, and density correction characteristic) or the like based on the measurement result, the stabilization control by the density adjustment can be performed. However, a method for the stabilization control of the present invention is not particularly limited. A different known method can be employed as long as density adjustment is performed.

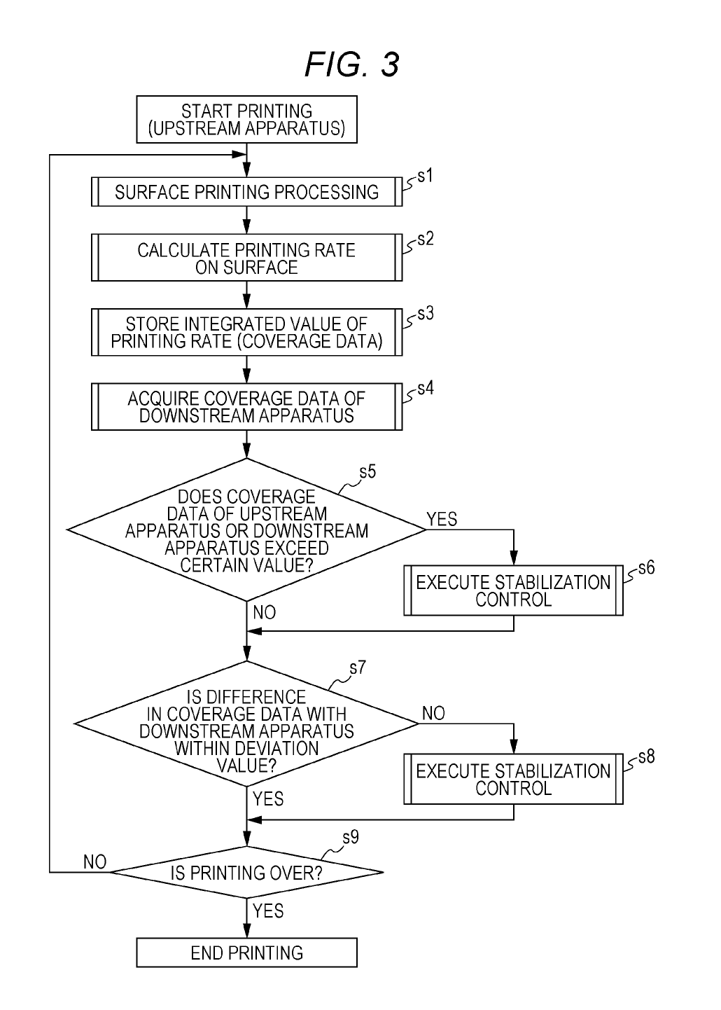

The determination of execution of the stabilization control can be performed in each image forming apparatus. Also, the determination may be performed in a specific image forming apparatus and a determination result may be notified to a different image forming apparatus when necessary. FIG. 3 is a flowchart illustrating a processing procedure of when the determination of execution of the stabilization control is performed in the image forming apparatus 1 which is the upstream apparatus. The following processing procedure is executed by a control unit including the CPU 100 and the like in the image forming apparatus 1.

First, when printing is started in the upstream apparatus, surface printing processing is performed (step s1) and a printing rate on the surface is calculated (step s2). The calculated printing rate is added to an integrated value already stored in a memory or the like and the updated integrated value is stored into the memory or the like (step s3). Also, coverage data transmitted from the image forming apparatus 2 which is the downstream apparatus is acquired through the I/O port 203 and the I/O port 103 (step s4). The transmission procedure by the image forming apparatus 2 will be described later. Also, the coverage transmitted from the downstream apparatus is stored into a memory or the like separately from coverage of the own apparatus.

In the control unit, it is determined whether each of the coverage of the upstream apparatus and the coverage of the downstream apparatus exceeds a predetermined value (certain value) (step s5). When either piece of coverage exceeds the certain value (step s5, Yes) and when the certain value is exceeded in the own apparatus, stabilization control by the own apparatus is performed (step s6). When the certain value is not exceeded in the own apparatus and when the certain value is exceeded in the different apparatus, an execution notice is given to the different apparatus through the I/O port 103 and the I/O port 203.

In the different apparatus which receives the execution notice, that is, in the image forming apparatus 2, control to execute the stabilization control is performed. As the control, immediately or appropriately, the stabilization control may be performed in the own apparatus automatically, or a display to prompt the execution of the stabilization control in the image forming apparatus 2 may be displayed on the display operation unit 140 or the like (step s6). The stabilization control can be performed immediately, but when it is not preferable to interrupt a job being currently printed, the stabilization control may be performed when one job is over or when all jobs are over. When the stabilization control is performed, the stored coverage is reset. As described, by performing the stabilization control regardless of a difference in the coverage of the both apparatuses, print quality can be kept adequate.

Note that in the above embodiment, control to execute the stabilization control is performed in an image forming apparatus which exceeds the certain value, but the control to execute the stabilization control can also be performed, as cooperative execution, in an image forming apparatus which does not exceed the certain value.

When both pieces of coverage data do not exceed the certain value (step s5, No), or after step s6, it is determined whether a difference between the coverage data of the upstream apparatus and the coverage data of the downstream apparatus is within a set deviation value (step s7). When the difference in the coverage data of the both apparatuses is within the deviation value (step s7, Yes), it is determined whether printing is over (step s9). When the printing is not over (step s9, No), processing goes back to step s1. When the printing is over (step s9, Yes), the printing ends.

In step s7, when the difference in the coverage data of the both apparatuses exceeds the deviation value, the stabilization control is performed in the own apparatus and an execution notice is given to the different apparatus through the I/O port 103 and the I/O port 203. In the different apparatus which receives the execution notice performs control to execute the stabilization control (step s8). Note that in the present embodiment, when the difference in the coverage data of the both apparatuses exceeds the deviation value, the stabilization control is performed in the both apparatuses. However, the stabilization control may be performed only in an apparatus with high coverage. After the stabilization control is executed (step s8), determination whether printing is over is performed in step s9, similarly to the above.

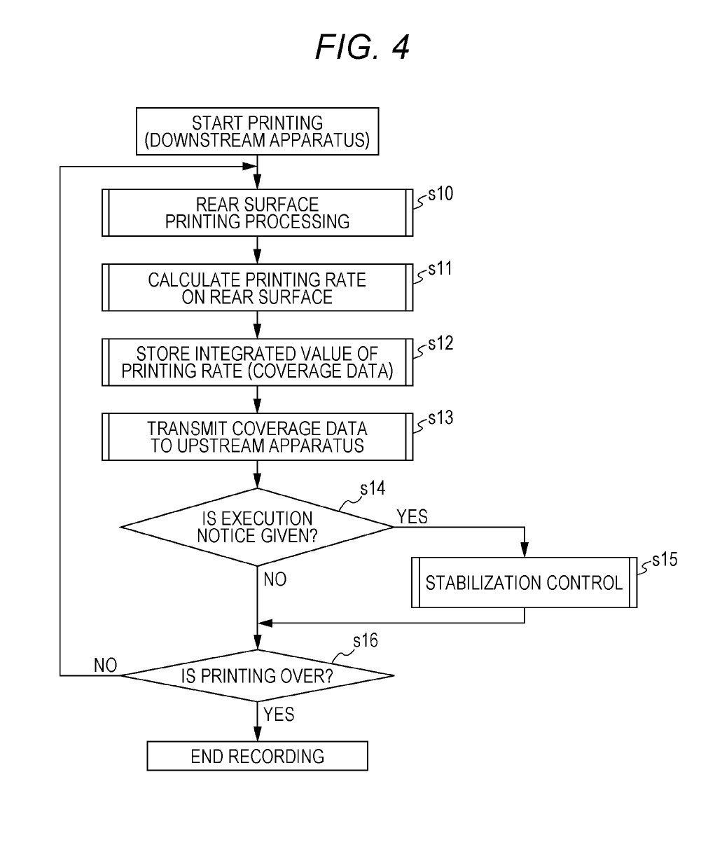

Next, a processing procedure in the image forming apparatus 2 which is the different apparatus will be described based on a flowchart in FIG. 4. The following processing procedure is executed by a control unit such as the CPU 200 of the image forming apparatus 2. When printing is started, rear surface printing processing is performed on paper a surface of which is printed in the image forming apparatus 1 (step s10). In the control unit, a printing rate on the rear surface is calculated (step s11). The calculated printing rate is added to an already-stored integrated value and the updated integrated value is stored into a memory or the like (step s12). The stored coverage data is transmitted to the image forming apparatus 1 through the I/O port 203 and the I/O port 103 (step s13).

Then, it is determined whether an execution notice is given from the upstream apparatus (step s14). When the execution notice is not given (step s14, No), it is determined whether printing is over (step s16). When the printing is not over (step s16, No), processing goes back to step s10. When the printing is over (step s10, Yes), the printing ends. When the execution notice is given from the image forming apparatus 1 which is the upstream apparatus (step s14, Yes), control to execute the stabilization control is performed in the image forming apparatus 2 (step s15). After the stabilization control is executed (step s15), determination whether printing is over is performed in step s16, similarly to the above.

In the above embodiment, the determination of execution of the stabilization control is performed in the image forming apparatus 1, but the determination of execution of the stabilization control can be performed in each of the image forming apparatuses 1 and 2. In such a case, the control unit in each of the image forming apparatuses functions as a control unit of the present invention.

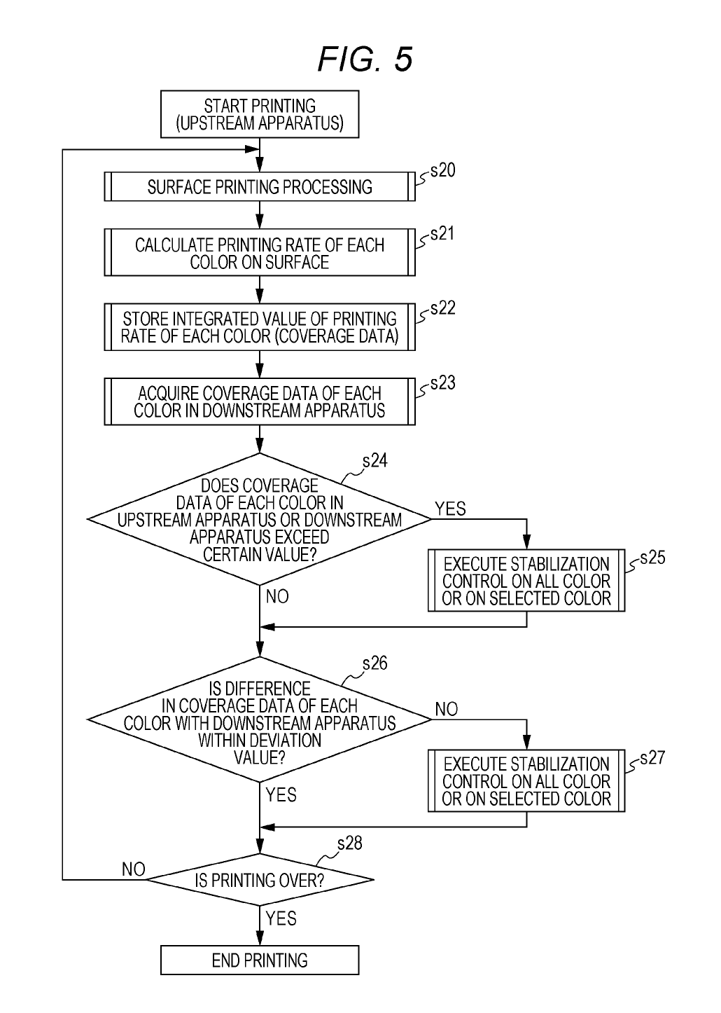

Also, in the above description, the stabilization control is performed regardless of a color even in a color apparatus. However, coverage data of each color may be acquired and the determination of execution of the stabilization control may be performed for each color. In the following, the processing procedure will be described based on a flowchart in FIG. 5. Note that in the present embodiment, the description will be made on the assumption that determination of the stabilization control is performed by the control unit in the image forming apparatus 1. However, as described, in each of the image forming apparatuses, coverage data of each color may be acquired and the determination of the stabilization control may be performed for each color.

When printing is started in the upstream apparatus, surface printing processing is performed (step s20) and a printing rate of each color on the surface is calculated (step s21). The calculated printing rate is added to an already-stored integrated value of each color and the updated integrated value is stored into a memory or the like (step s22). Also, coverage data of each color transmitted from the image forming apparatus 2 which is the downstream apparatus is acquired through the I/O port 203 and the I/O port 103 (step s23). The coverage data of each color transmitted from the downstream apparatus is stored into a memory or the like.

In the control unit, it is determined whether each of the coverage of each color in the upstream apparatus and the coverage of each color in the downstream apparatus exceeds a certain value (step s24). When any piece of the coverage of each color exceeds the certain value (step s24, Yes) and when the certain value is exceeded in the own apparatus, the stabilization control by the own apparatus is performed (step s25). When the certain value is not exceeded in the own apparatus and when the certain value is exceeded in the different apparatus depending on a color, an execution notice is given to the different apparatus through the I/O port 103 and the I/O port 203. In the different apparatus which receives the execution notice, that is, in the image forming apparatus 2, control to execute the stabilization control is performed (step s25).

In an image forming apparatus in which coverage of any color exceeds the certain value, the stabilization control may be performed on all colors or the stabilization control may be performed only on a color which exceeds the certain value. Also, the stabilization control may be performed on the color which exceeds the certain value and on a selected color which is related thereto. Moreover, a predetermined value may be different depending on a color. When the stabilization control is performed, coverage of the color is reset. Note that in the above embodiment, control to execute the stabilization control is performed only in the image forming apparatus which exceeds the certain value, but the control to execute the stabilization control can also be performed, as cooperative execution, in an image forming apparatus which does not exceed the certain value.

When coverage data of all colors does not exceed the certain value (step s24, No), or after step s25, it is determined, for each color, whether a difference between the coverage data of each color in the upstream apparatus and the coverage data of each color in the downstream apparatus is within the deviation value (step s26). When the coverage data of each color in the both apparatuses is within the deviation value (step s26, Yes), it is determined whether printing is over (step s28). When the printing is not over (step s28, No), processing goes back to step s20. When the printing is over (step s28, Yes), the printing ends. In step s26, when any difference in the coverage data of each color in the both apparatuses exceeds the deviation value, the stabilization control is performed in the own apparatus and an execution notice is given to the different apparatus through the I/O port 103 and the I/O port 203. In the different apparatus which receives the execution notice performs control to execute the stabilization control.

Note that in an image forming apparatus, in which coverage of any color exceeds the certain value, the stabilization control may be performed on all colors or the stabilization control may be performed only on a color which exceeds the certain value. Also, the stabilization control may be performed on the color which exceeds the certain value and a selected color. Moreover, a predetermined value may be different depending on a color. Note that in the present embodiment, the stabilization control is performed in the both apparatuses in such a case. However, the stabilization control may be performed only in an apparatus with high coverage. After the stabilization control is executed (step s27), determination whether printing is over is performed in step s28, similarly to the above.

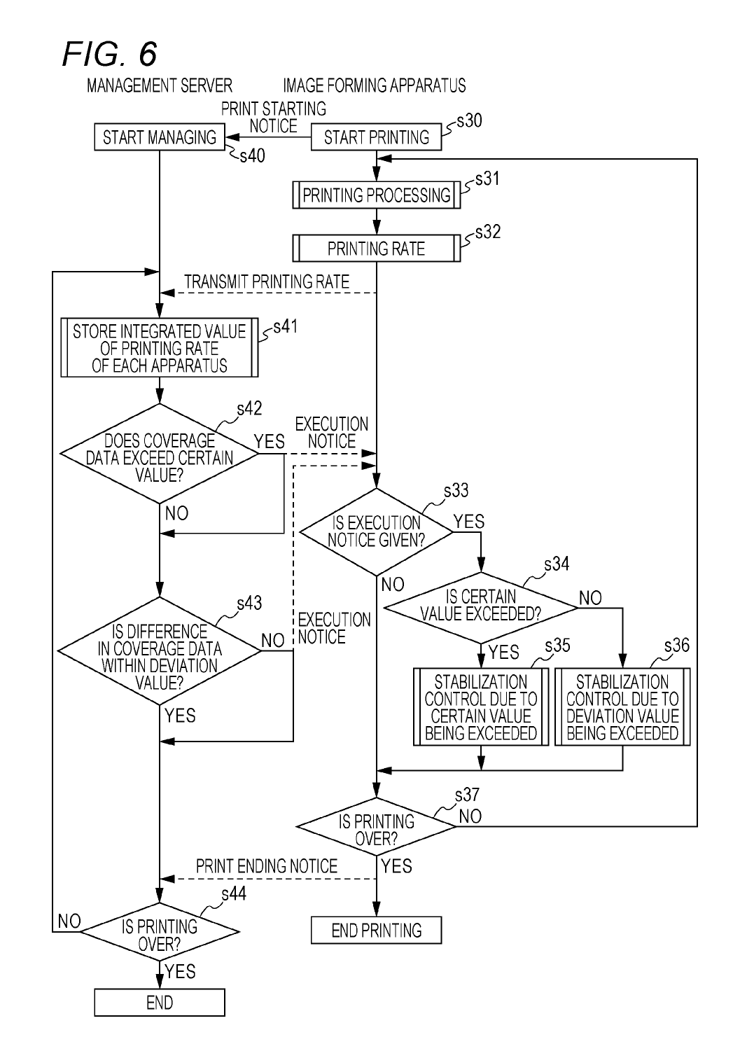

Note that in each of the above embodiments, the determination of execution of the stabilization control is performed in any of the image forming apparatuses or in each of the image forming apparatuses. However, the determination of execution of the stabilization control may be performed by managing coverage in the management server 5. The processing procedure will be described based on a flowchart in FIG. 6. The following processing procedure is executed by control by the management control unit 500. Note that a predetermined value and a deviation value with which execution of the stabilization control is determined are stored in the management control unit. Also, a control unit in each image forming apparatus functions as an image forming apparatus control unit.

When printing is started in any of the image forming apparatuses (step s30), a print starting notice is given to the management server 5 and the management server 5 starts managing the stabilization control (step s40). In each of the image forming apparatuses, printing processing is performed and a printing rate is calculated (step s32). The calculated printing rate is transmitted to the management server 5 via the network communication unit 510 through the modems 120 and 220 and the network 6. The management server 5 stores an integrated value (coverage) of each apparatus. The management server 5 updates and stores an integration rate when receiving a new printing rate (step s41).

Based on coverage data in each apparatus, the management server 5 determines whether the coverage data in any of the image forming apparatuses exceeds a certain value (step s42). When the coverage data of any of the image forming apparatuses exceeds the certain value, an execution notice is given to the corresponding image forming apparatus via the network 6 (step s42, Yes). After the execution notice is given, or when none of the image forming apparatuses exceeds the predetermined value (step s42, No), it is determined whether a difference between pieces of the coverage data of the image forming apparatuses is within a deviation value (step s43).

When any difference between the pieces of the coverage data is not within the deviation value (step s43, No), an execution notice is given to the corresponding image forming apparatus (step s43). After the execution notice is given, or when the difference is within the deviation value (step s43, Yes), the management server 5 determines, after the determination, whether printing is over (step s44). When the printing is not over (step s44, No), processing goes back to step s41. When the printing is over (step s44, Yes), the management ends.

In each of the image forming apparatuses, after the printing rate is calculated, it is determined whether an execution notice is given from the management server 5 (step s33). When no execution notice is received, it is determined whether printing is over (step s37). When the printing is not over (step s37, No), processing goes back to step s31 and the processing is continued. When the printing is over (step s37, Yes), a printing completion notice is given to the management server 5 via the network 6 and the printing ends. When it is determined that the execution notice is given in step s33 (step s33, Yes), it is determined whether the stabilization execution is due to the certain value being exceeded (step s34).

When the stabilization execution is due to the certain value being exceeded (step s34, Yes), in a corresponding image forming apparatus, control to execute the stabilization control is performed due to the certain value being exceeded (step s35). When the stabilization control is executed, a notice is given to the management server 5 and the management server resets an integrated value in the corresponding image forming apparatus.

When the stabilization control is not due to the certain value being exceeded (step s34, No), a difference exceeds the deviation value. Thus, in each of the image forming apparatuses which exceed the deviation value, control to execute the stabilization control is performed due to the deviation value being exceeded (step s36). When the stabilization control is executed, a notice is given to the management server 5 and the management server 5 resets an integrated value in the corresponding image forming apparatus. After step s35 and step s36, the described determination of printing processing is performed.

In the above, the present invention has been described based on the above embodiments, but arbitrary modification can be made without departing from the scope of the present invention.

As described, according to an aspect of the present invention, it becomes possible to reduce variation of a difference in coverage between image forming apparatuses in series-tandem connection and to improve print quality printed by the plurality of image forming apparatuses.

Although the present invention has been described and illustrated in detail, it is clearly understood that the same is by way of illustration and example only and is not to be taken by way of limitation, the scope of the present invention being interpreted by terms of the appended claims.

1. An image forming apparatus which can be connected to a different image forming apparatus in series-tandem, comprising:
an image forming unit configured to perform image forming based on image data;
a communication unit configured to communicate with the different image forming apparatus; and
a control unit configured to control the image forming and the communication,
wherein the control unit acquires own apparatus coverage in print history of the own apparatus, acquires different apparatus coverage in print history of the different image forming apparatus through the communication unit, and compares the own apparatus coverage and the different apparatus coverage, and when the own apparatus coverage is high and a difference therebetween exceeds a predetermined deviation value, the control unit performs control to execute stabilization control by density adjustment.

2. The image forming apparatus according to claim 1, wherein the control unit transmits the own apparatus coverage to the different image forming apparatus through the communication unit.

3. The image forming apparatus according to claim 1, wherein when the own apparatus coverage exceeds a predetermined value, the control unit performs control to execute the stabilization control.

4. The image forming apparatus according to claim 1, wherein when executing the stabilization control, the control unit gives an execution notice to the different image forming apparatus through the communication unit.

5. The image forming apparatus according to claim 4, wherein when executing the stabilization control cooperatively, the control unit gives the execution notice.

6. The image forming apparatus according to claim 5, wherein when the difference in the coverage exceeds the predetermined deviation value and the stabilization control is performed, the control unit gives the execution notice including the cooperative execution.

7. The image forming apparatus according to claim 1, wherein when receiving an execution notice of the stabilization control from the different image forming apparatus through the communication unit, the control unit performs control to execute the stabilization control.

8. The image forming apparatus according to claim 1, wherein the control unit compares the own apparatus coverage and the different apparatus coverage and gives, when the different apparatus coverage is high and a difference therebetween exceeds a predetermined deviation value, a notice of the stabilization control to perform density adjustment to the different image forming apparatus through the communication unit.

9. The image forming apparatus according to claim 1, wherein when the different apparatus coverage exceeds a predetermined value, the control unit gives a notice of the stabilization control to perform density adjustment to the different image forming apparatus through the communication unit.

10. The image forming apparatus according to claim 1, wherein the control unit acquires own apparatus coverage and different apparatus coverage of each color and performs, for each color, determination of execution of the stabilization control.

11. The image forming apparatus according to claim 10, wherein in the stabilization control, the control unit performs density adjustment on all colors or on a selected color.

12. The image forming apparatus according to claim 11, wherein the selected color on which the control unit performs the density adjustment is a color coverage of which exceeds a predetermined deviation value or a predetermined value.

13. The image forming apparatus according to claim 10, wherein the control unit performs the determination with the predetermined deviation value being different for each color.

14. The image forming apparatus according to claim 10, wherein the control unit performs the determination with the predetermined value being different for each color.

15. The image forming apparatus according to claim 1, wherein each of the own apparatus coverage and the different apparatus coverage is an integrated value of coverage in predetermined print history.

16. The image forming apparatus according to claim 1, wherein the control to execute the stabilization control is either or both of automatically performing the stabilization control and giving a notice.

17. An image forming system in which the image forming apparatus according to claim 1 and the different image forming apparatus according to claim 1 are connected in series-tandem.

18. An image forming system comprising:
a plurality of image forming apparatuses in series-tandem connection, each of which includes an image forming unit configured to form an image based on image data, a network communication unit which is connected to a network and is configured to perform network communication with an external part, and an image forming apparatus control unit configured to control the image forming and the network communication; and
a management server including a management server communication unit which is connected to each of the image forming apparatuses via the network, and a management control unit configured to manage each of the image forming apparatuses,
wherein the management control unit acquires, via the network, coverage in print history of each of the image forming apparatuses and when a difference in the coverage exceeds a predetermined deviation value, the management control unit at least gives a notice of executing stabilization control by density adjustment in an image forming apparatus with high coverage in the image forming apparatuses having the difference.

19. The image forming system according to claim 18, wherein when receiving the notice of executing the stabilization control, each of the image forming apparatuses performs the control to execute the stabilization control.

20. The image forming system according to claim 18, wherein the management control unit gives a notice of executing the stabilization control by density adjustment in an image forming apparatus coverage of which exceeds a predetermined deviation value.

21. The image forming system according to claim 18, wherein when any piece of the coverage exceeds a predetermined value, the management control unit gives a notice of executing the stabilization control at least in a corresponding image forming apparatus.

22. The image forming system according to claim 18, wherein the management control unit acquires coverage of each color and performs, for each color, determination of execution of the stabilization control.

23. The image forming system according to claim 22, wherein in the stabilization control, the management control unit gives a notice of executing the stabilization control to all colors or a selected color.

24. The image forming system according to claim 23, wherein the selected color on which density adjustment is performed is a color coverage of which exceeds a predetermined deviation value or a predetermined value.

25. An image forming method comprising:
acquiring first coverage in print history of a first image forming apparatus and a second coverage in print history of a second image forming apparatus;
comparing the first coverage and the second coverage; and
performing, when either piece of the coverage is high and a difference therebetween exceeds a predetermined deviation value, control to execute stabilization control to perform density adjustment at least in an image forming apparatus with the high coverage.
